(19) United States
(12) Patent Application Publication
(10) Pub. No.: US 2024/0359340 A1
(43) Pub. Date: Oct. 31, 2024

(54) GRIPPER STRUCTURE

(71) Applicant: Delta Electronics, Inc., Taoyuan City (TW)

(72) Inventors: Hsin-Hua Chen, Taoyuan City (TW); Shang-Wei Yang, Taoyuan City (TW); Hsin-Hsien Wu, Taoyuan City (TW)

(21) Appl. No.: 18/238,386

(22) Filed: Aug. 25, 2023

(30) Foreign Application Priority Data
Apr. 28, 2023 (CN) 202310473331.6

(51) Int. Cl. B25J 15/02; B25J 15/04

(52) U.S. Cl. CPC B25J 15/026; B25J 15/0286; B25J 15/045

(57) ABSTRACT

A gripper structure is disclosed and includes a screw-rod main body, a first rotatory nut, a second rotatory nut, a first driving module, a second driving module, a first clamping element and a second clamping element. The first rotatory nut and the second rotatory nut are disposed on two sides of the screw-rod main extended along a first direction body, respectively, and bilaterally symmetrical to each other. The first driving module and the second driving module are configured to drive the first rotatory nut and the second rotatory nut to rotate, respectively. The first rotatory nut and the second rotatory nut are allowed to pass through a midline of the screw-rod main body. When the first driving module drives the first rotatory nut or/and the second driving module drives the second rotatory nut, the first clamping element and the second clamping element are relatively displaced in the first direction to achieve a clamping operation.

### CROSS-REFERENCE TO RELATED APPLICATION

This application claims priority to China Patent Application No. 202310473331.6, filed on Apr. 28, 2023. The entire contents of the above-mentioned patent application are incorporated herein by reference for all purposes.

### FIELD OF THE INVENTION

The present disclosure relates to a gripper structure, and more particularly to a long-stroke gripper structure having a single screw rod combined with two rotatory nuts, so as to allow the clamping elements connected to the rotatory nuts to move in full region without the midline restriction of the screw rod, avoid the torsional loss and enhance the support strength at the same time.

### BACKGROUND OF THE INVENTION

A robotic arm is an automatic control device having the function of imitating a human arm and capable of completing various tasks, and has been widely used in the automated mechanical device. In addition to being mainly used in industrial manufacturing, the applications of the robotic arm are found in the fields of the commercial agriculture, the medical rescue, the entertainment service and the military security. The structure of the robotic arm includes a mechanical main body, a controller, a servo mechanism and a sensor, and a certain designated action of the robotic arm is set by the program according to the operation requirement. The device installed at the end of the robotic arm for gripping an object directly is usually called as a gripper, an end effector or a robot hand. Its purpose is to replace the human fingers, skillfully complete many complex tasks or manipulate various objects. However, for different working tasks, different driving methods are often selected to construct the gripper structure.

Take the common long-stroke gripper structure on the market as an example. The gripper structure includes a left-handed screw rod and a right-handed screw rod, and the belt pulleys are added to the left-handed screw rod and the right-handed screw rod, respectively. When the motors are rotated to drive the belts, the belts further drive the screw rods to rotate. By the rotation of the screw rods arranged on both sides, the rotatory nuts drive the clamping bases on both sides to move, thereby achieving the clamping operation. The screw rods on both sides are controlled to rotate by the corresponding motors, respectively, and the corresponding rotatory nuts and the clamping bases are driven to move and complete the clamping operation simultaneously. However, the clamping bases arranged on both sides can only move within the range of the length of the corresponding screw rods. The movement of the respective clamping base is limited, and it is not allowed to cross the midline restriction.

Therefore, there is a need of providing a gripper structure having a single screw rod combined with two rotatory nuts, so as to allow the clamping elements connected to the rotatory nuts to move in full region without the midline restriction of the screw rod, avoid the torsional loss, enhance the support strength and obviate the drawbacks encountered by the prior arts.

### SUMMARY OF THE INVENTION

An object of the present disclosure is to provide a gripper structure having a single screw rod combined with two rotatory nuts, so as to allow the clamping elements connected to the rotatory nuts to move in full region without the midline restriction of the screw rod, avoid the torsional loss and enhance the support strength at the same time.

Another object of the present disclosure is to provide a gripper structure. The two rotatory nuts are connected to the corresponding driving modules, respectively, and configure to dispose on a single long-stroke screw rod. When the driving module, such as the motor combined with the belt, drives the corresponding rotatory nut to rotate, each of the two rotatory nuts is allowed to move arbitrarily on the screw-rod main body, so as to achieve the clamping operation without being limited by the midline of the screw-rod main body or the synchronous displacement of the two rotatory nuts. On the other hand, when the driving module and the corresponding rotatory nut are displaced and moved at the same time and the clamping element is connected thereto for the clamping operation, the driving module is stressed directly, and the problem of torsional loss due to the length of the screw-rod main body rod is avoided. In addition, the driving modules are disposed on one single screw-rod main body through the rotatory nuts, and the supporting positions of the driving modules are movable. When the rotatory nuts drive the clamping elements to perform the clamping operation, the force-bearing positions of the driving modules and the rotatory nuts are the supporting positions. It facilitates to enhance the supporting strength of the driving modules.

A further object of the present disclosure is to provide a gripper structure. Since two sets of driving modules are respectively mounted on one single long-stroke screw-rod main body through the corresponding rotatory nuts, it allows to move the respective one of the driving modules and the rotatory nuts without being limited by the midline of the screw-rod main body. When the stroke length of the gripper structure needs to be increased, an extension screw can be added at one end and/or both ends of the screw-rod main body to increase the stroke length. There is no need to redesign the gripper structure. It helpful of increasing the diversity of product applications.

In accordance with an aspect of the present disclosure, a gripper structure is provided and includes a screw-rod main body, a first rotatory nut, a second rotatory nut, a first driving module, a second driving module, a first clamping element and a second clamping element. The screw-rod main body is extended along a first direction. The first rotatory nut and the second rotatory nut are sleeved on two sides of the screw-rod main body, respectively, and bilaterally symmetrical to each other. The first driving module is connected to the first rotatory nut, and configured to drive the first rotatory nut to rotate and displace relative to the screw-rod main body in the first direction, wherein the first rotatory nut is allowed to pass through a midline of the screw-rod main body. The second driving module is connected to the second rotatory nut, and configured to drive the second rotatory nut to rotate and displace relative to the screw-rod main body in the first direction, wherein the second rotatory nut is allowed to pass through the midline of the screw-rod main body. The first clamping element and the second clamping element are connected to the first rotatory nut and the second rotatory nut, respectively, wherein when the first driving module drives the first rotatory nut or/and the second driving module drives the second rotatory nut, the first clamping element and the second clamping element are relatively displaced in the first direction and cooperated with each other to achieve a clamping operation.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective structural view illustrating a gripper structure according to a first embodiment of the present disclosure;

FIG. 2 is a cross-sectional view illustrating the gripper structure according to the first embodiment of the present disclosure;

FIG. 3 is an internal structural view illustrating the gripper structure according to the first embodiment of the present disclosure;

FIGS. 4A to 4C are front views illustrating different relative displacements between the first clamping element and the second clamping element in the gripper structure according to the first embodiment of the present disclosure;

FIG. 5 is a perspective structural view illustrating a gripper structure according to a second embodiment of the present disclosure;

FIG. 6 is an exploded view illustrating the gripper structure according to the second embodiment of the present disclosure;

FIG. 7 is a cross-sectional view illustrating the gripper structure according to the first embodiment of the present disclosure;

FIG. 8 is a schematic diagram showing that the extension plate is connected to the main fixing plate through the connection component;

FIG. 9A is a perspective structural view illustrating the connection component;

FIG. 9B is a cross-sectional structural view illustrating the connection component;

FIG. 10A is a schematic diagram showing that the screw-rod main body and the extension screw are disassembled apart from each other;

FIG. 10B is a schematic diagram showing that the screw-rod main body and the extension screw are assembled with each other;

FIG. 11 is a cross-sectional structural view illustrating an exemplary combination of the screw-rod main body and the extension screw;

FIG. 12 is a cross-sectional structural view illustrating another exemplary combination of the screw-rod main body and the extension screw;

FIG. 13 is a perspective structural view illustrating the docking portion of the extension screw;

FIG. 14 is a front view illustrating the docking portion of the extension screw;

FIG. 15 is an exploded view illustrating the screw-rod main body and the extension screw docked through an exemplary docking element;

FIG. 16 is a cross-sectional view illustrating the screw-rod main body and the extension screw docked through an exemplary docking element;

FIG. 17 is an exploded view illustrating the screw-rod main body and the extension screw docked through another exemplary docking element; and

FIG. 18 is a cross-sectional view illustrating the screw-rod main body and the extension screw docked through another exemplary docking element.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “front,” “rear,” “left,” “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

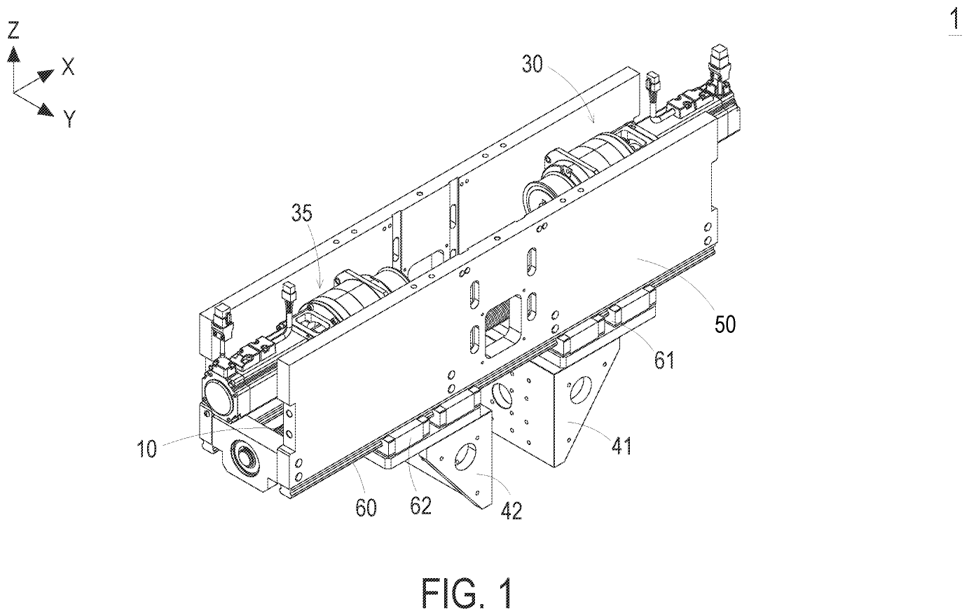

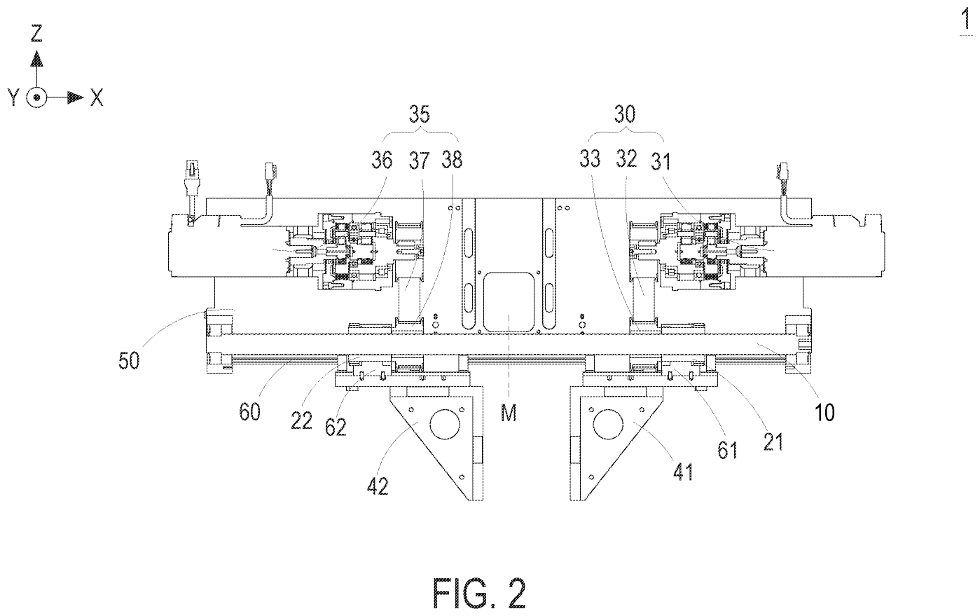

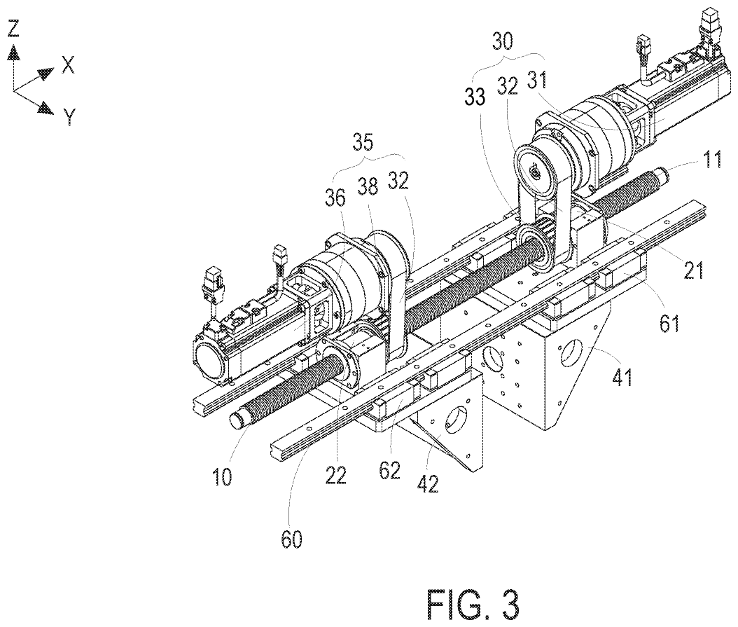

Please refer to FIG. 1 to FIG. 3. In the embodiment, the present disclosure provides a gripper structure 1 including a screw-rod main body 10, a first rotatory nut 21, a second rotatory nut 22, a first driving module 30, a second driving module 35, a first clamping element 41 and a second clamping element 42. The screw-rod main body 10 is extended along a first direction (i.e., the X axial direction). The first rotatory nut 21 and the second rotatory nut 22 are rotatory nuts, sleeved on two sides of the screw-rod main body 10, respectively, and bilaterally symmetrical to each other. When the first rotatory nut 21 and the second rotatory nut 22 are driven to rotate relative to the screw-rod main body 10 by the first driving module 30 and the second driving module 35, respectively, the first rotatory nut 21 and the second rotatory nut 22 are acted by the main external thread 11 of the screw-rod main body 10, so as to displace relative to the screw-rod main body 10. In the embodiment, the first driving module 30 is connected to the first rotatory nut 21, and configured to drive the first rotatory nut 21 to rotate and displace relative to the screw-rod main body 10 in the first direction (i.e., the X axial direction). Notably, the first rotatory nut 21 is allowed to pass through a midline M of the screw-rod main body 10. In addition, the second driving module 35 is connected to the second rotatory nut 22, and configured to drive the second rotatory nut 22 to rotate and displace relative to the screw-rod main body 10 in the first direction (i.e., the X axial direction). Notably, the second rotatory nut 22 is allowed to pass through the midline M of the screw-rod main body 10. In the embodiment, the first clamping element 41 and the second clamping element 42 are connected to the first rotatory nut 21 and the second rotatory nut 22, respectively. In the embodiment, the displacements of the first rotatory nut 21 and the second rotatory nut 22 on the screw-rod main body 10 are driven by the first driving module 30 and the second driving module 35, respectively, and can be performed independently. When the first driving module 30 drives the first rotatory nut 21 or/and the second driving module 35 drives the second rotatory nut 22, the first clamping element 41 and the second clamping element 42 are relatively displaced in the first direction (i.e., the X axial direction), and cooperated with each other to achieve a clamping operation.

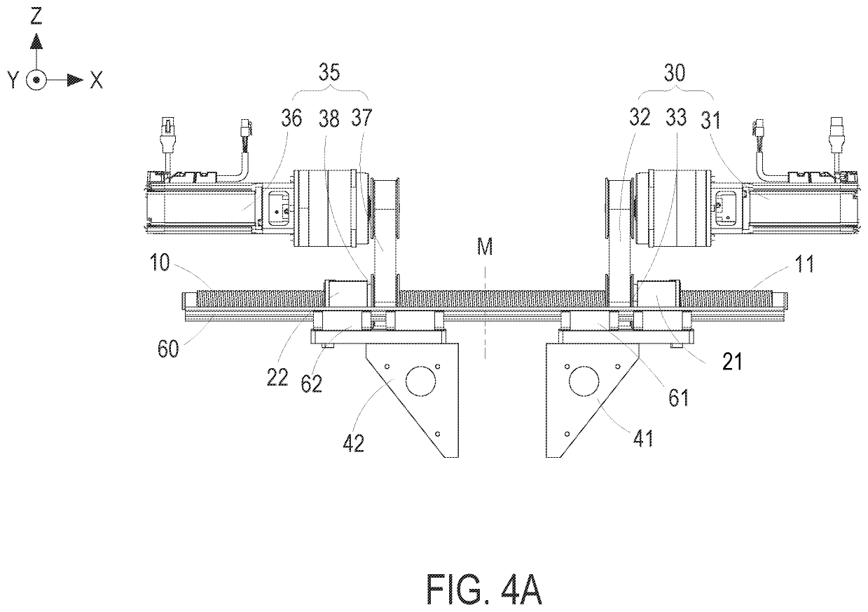

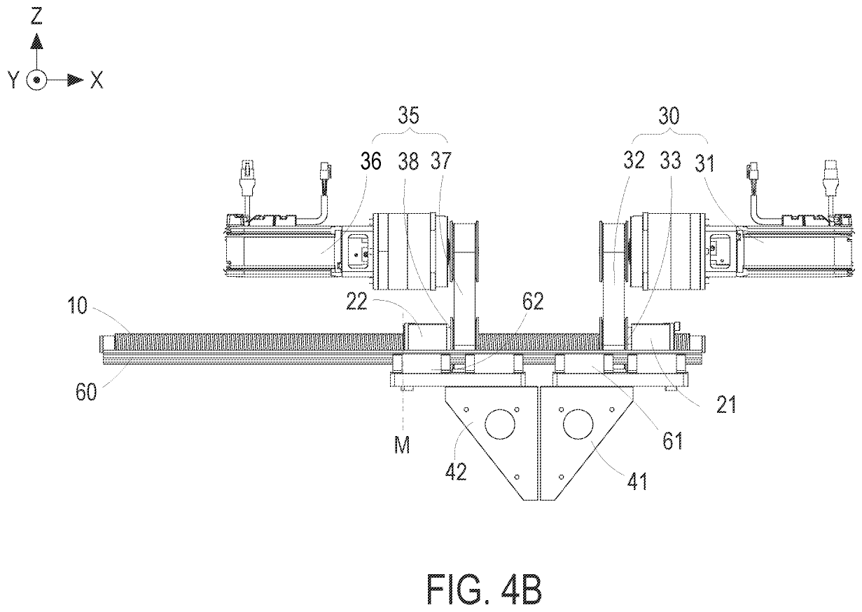

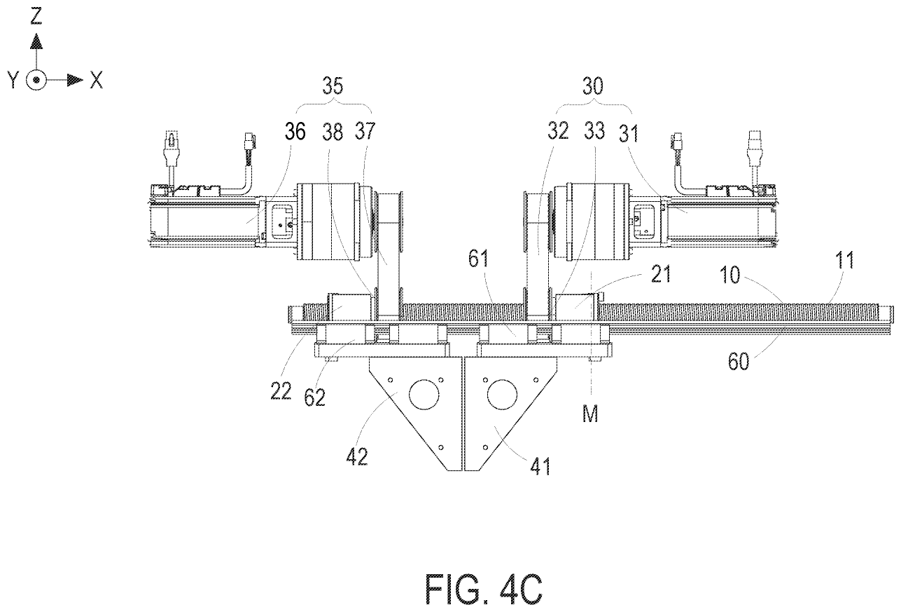

In the embodiment, when the gripper structure 1 performs the clamping operation, the first driving module 30 is independently enabled to drive the first rotatory nut 21 and the first clamping element 41, or the second driving module 35 is independently enabled to drive the second rotatory nut 22 and the second clamping 42. In other embodiments, it allows to enable the first driving module 30 and the second driving module 35 at the same time. The displacement of the first clamping element 41 relative to the second clamping element 42 is not limited to the symmetrical displacement or the synchronous displacement. In an embodiment, the first clamping element 41 driven by the first driving module 30 and the first rotatory nut 21, and the second clamping element 42 driven by the second driving module 35 and the second rotatory nut 22 are displaced to the left side and the right side of the midline M, respectively, so that the first clamping element 41 and the second clamping element 42 located on both sides are spaced differently from the midline M, as shown in FIG. 4A. In another embodiment, the first clamping element 41 driven by the first driving module 30 and the first rotatory nut 21, and the second clamping element 42 driven by the second driving module 35 and the second rotatory nut 22 are both displaced to the right side of the midline M (as shown in FIG. 4B), or both displace to the left side of the midline M (as shown in FIG. 4C). In other words, the single screw-rod main body 10 combines the two of the first rotatory nut 21 and the second rotatory nuts 22, and the first clamping element 41 connected to the first rotatory nut 21 or the second clamping element 42 connected to the second rotatory nut 22 are allowed to move in the full region of the screw-rod main body 10, and not restricted by the midline M. Furthermore, the torsional loss is avoided and the supporting strength is enhanced at the same time.

In the embodiment, the gripper structure 1 further includes a main fixing plate 50. Preferably but not exclusively, two parallel main fixing plates 50 are spliced together to form a fixing frame, or one single main fixing plate 50 is served as a fixing frame. In the following descriptions of the embodiments, one single main fixing plate 50 is used for illustration, and the present disclosure is not limited thereto. In the embodiment, the screw-rod main body 10 is disposed and fixed on the main fixing plate 50. The manner of disposing the screw-rod main body 10 on the main fixing plate 50 is not limited in the present disclosure. Moreover, in the embodiment, the gripper structure 1 further includes a linear real 60, a first sliding block 61 and a second sliding block 62. Preferably but not exclusively, the linear rail 60 includes two front and rear rails 60, and each of them can be used alone. In the following descriptions of the embodiments, one single linear rail 60 is used for illustration, and the present disclosure is not limited thereto. In the embodiment, the linear rail 60 is disposed on the main fixing plate 50 along the first direction (i.e., the X axial direction) and spatially corresponding to the screw-rod main body 10. Preferably but not exclusively, the linear rail 60 and the screw-rod main body 10 are parallel to each other. In the embodiment, the first sliding block 61 and the second sliding block 62 are arranged across the paired linear rails 60, respectively. The first clamping element 41 is connected to the first rotatory nut 21 through the first sliding block 61, and the first rotatory nut 21, the first sliding block 61 and the first clamping element 41 are allowed to displace relative to the screw-rod main body 10 and the linear rail 60 smoothly in the first direction (i.e., the X axial direction). In addition, the second clamping element 42 is connected to the second rotatory nut 22 through the second sliding block 62, and the second rotatory nut 22, the second sliding block 62 and the second clamping element 42 are allowed to displace relative to the screw-rod main body 10 and the linear rail 60 smoothly in the first direction (i.e., the X axial direction).

In the embodiment, the first driving module 30 includes a motor 31, a belt 32 and a pulley 33. The pulley 33 is concentrically connected with the first rotatory nut 21. The motor 31 drives the pulley 33 and the first rotatory nut 21 to rotate through the belt 32, and the first rotatory nut 21 is allowed to drive the first clamping element 41 to move relative to the screw-rod main body 10 in the first direction (i.e., the X axial direction). Moreover, in the embodiment, the second driving module 35 includes a motor 36, a belt 37 and a pulley 38. The pulley 38 is concentrically connected with the second rotatory nut 22. The motor 36 drives the pulley 38 and the second rotatory nut 22 to rotate through the belt 37, and the second rotatory nut 22 is allowed to drive the second clamping element 42 to move relative to the screw-rod main body 10 in the first direction (i.e., the X axial direction). Certainly, the manner in which the first driving module 30 drives the first rotatory nut 21 and the second driving module 35 drives the second rotatory nut 22 is not limited to the types of the motors 31, 36, belts 32, 37 and the pulleys 33, 38. It is adjustable according to the practical requirements.

Notably, in the embodiment, the two rotatory ones of the first rotatory nut 21 and the second rotatory nut 22 are connected to the first driving module 30 and the second driving module 35, respectively, and matched and sleeved on the single long-stroke screw-rod main body 10, so as to be acted by the main external thread 11. When the first driving module 30 drives the corresponding first rotatory nut 21 to rotate or/and the second driving module 35 drives the corresponding second rotatory nut 22 to rotate, two rotatory ones of the first rotatory nut 21 and the second rotatory nut 22 are allowed to move arbitrarily on the screw-rod main body 10, so as to achieve the clamping operation without being limited by the midline M of the screw-rod main body 10 or the synchronous displacement of the two rotatory ones of the first rotatory nut 21 and the second rotatory nut 22. On the other hand, the first driving module 30 and the first rotatory nut 21 are displaced and moved at the same time, and the second driving module 35 and the second rotatory nut 22 are displaced and moved at the same time. When the first rotatory nut 21 and the second rotatory nut 22 are connected to the first clamping element 41 and the second clamping element 42, respectively, for the clamping operation, the first driving module 30 and the second driving module 35 are stressed directly, and the problem of torsional loss due to the length of the screw-rod main body rod 10 is avoided. In addition, the first driving module 30 is disposed on one single screw-rod main body 10 through the first rotatory nut 21, the second driving module 35 is disposed on one single screw-rod main body 10 through the second rotatory nut 22, and the supporting positions of the first driving module 30 and the second driving module 35 are movable. When the first rotatory nut 21 drives the first clamping element 41 and the second rotatory nut 22 drives the second clamping element 42 to perform the clamping operation, the force-bearing position of the first driving module 30 and the first rotatory nut 21 and the force-bearing position of the second driving module 35 and the second rotatory nut 22 are the supporting positions. It facilitates to enhance the supporting strength of the first driving module 30 and the second driving module 35.

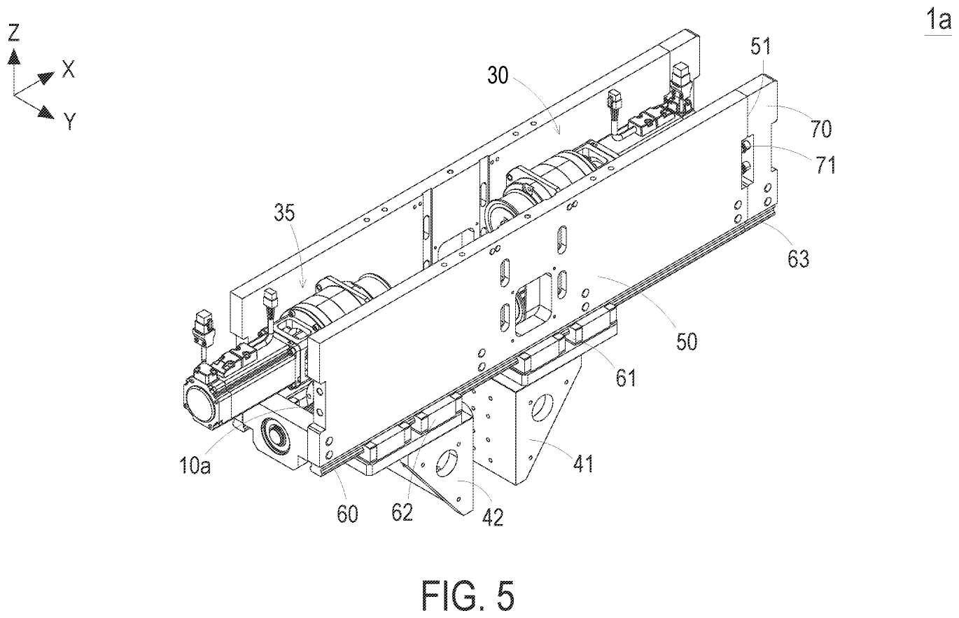

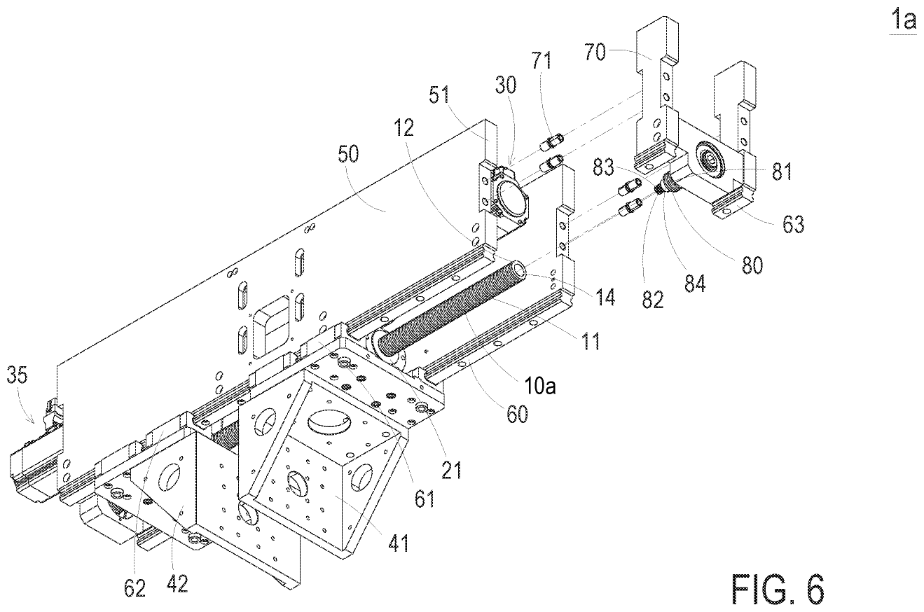

Please refer to FIG. 5 to FIG. 7. They illustrate a gripper structure 1a according to a second embodiment of the present disclosure. In the embodiment, the structures, elements and functions of the gripper structure 1a are similar to those of the gripper structure 1 of FIG. 1 to FIG. 3, and are not redundantly described herein. In the embodiment, the gripper structure 1a further includes an extension plate 70, an extension screw 80 and an extension rail 63 for increasing the stroke length of the gripper structure 1a. In the embodiment, the extension plate 70 is detachable docked to a lateral end 51 of the main fixing plate 50 through a connection component 71 in the first direction (i.e., the X axial direction). Preferably but not exclusively, the connection component 71 does not exceed an overlapping range of the extension plate 70 and the main fixing plate 50 along the first direction in a viewing direction of the first direction (i.e., the X axial direction). In this way, the main fixing plate 50 and the extension plate 70 are fixed in a serial connection manner, the vertical stacking and fastening in the Y axial direction or the Z axial direction is avoided, and the overall plate thickness is not increased. Preferably but not exclusively, the structural support for the extension screw 80 and the extension rail 63 is provided by the extension plate 70.

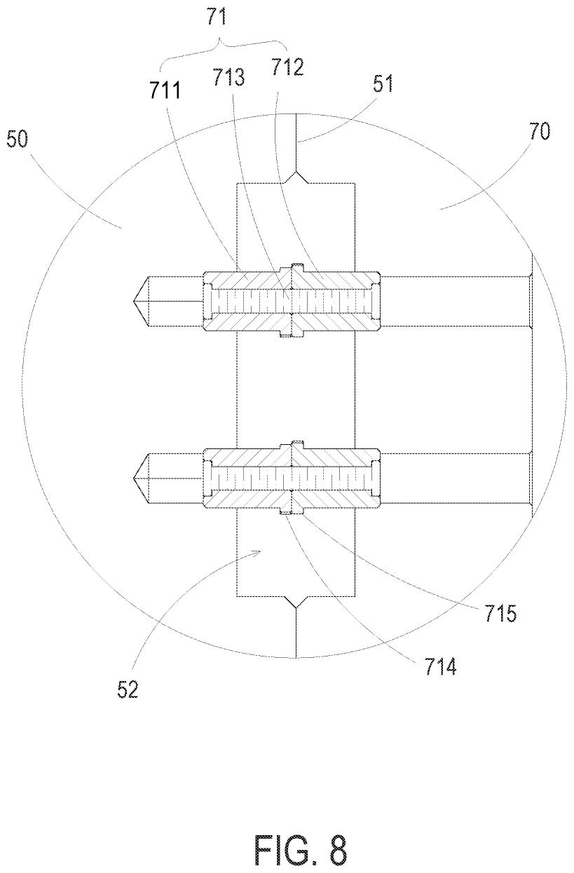

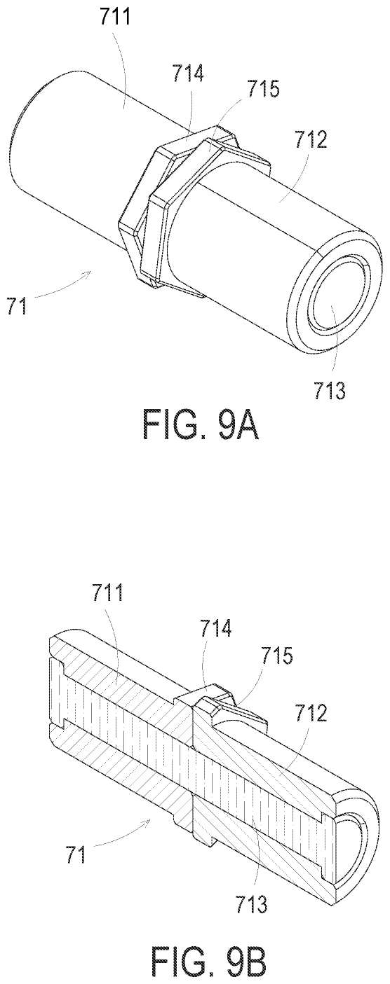

Please refer to FIG. 5 to FIG. 8, FIG. 9A and FIG. 9B. In the embodiment, the connection component 71 connected between the main fixing plate 50 and the extension plate 70 further includes a first fastening element 711, a second fastening element 712 and a restricting element 713. Preferably but not exclusively, the first fastening element 711 and the second fastening element 712 are two screws arranged concentrically. An operation end 714 of the first fastening element 711 and an operation end 715 of the second fastening element 712 face each other, and the restricting element 713 is disposed between the first fastening element 711 and the second element 712 and configured to restrict an axial direction between the first fastening element 711 and the second fastening element 712. In that, it allows to drive the first fastening element 711 and the second fastening element 712 to rotate around the axis, but the detachment of the first fastening element 711 and the second fastening element 712 is avoided. In the embodiment, the main fixing plate 50 and the extension plate 70 are docked with each other to form a window 52, and the operation end 714 of the first fastening element 711 and the operation end 715 of the second fastening element 712 are exposed through the window 52. In that, it allows the user to operate the first fastening element 711 and the second fastening element 712 through the window 52 to achieve the connection of the main fixing plate 50 and the extension plate 70. In the embodiment, the first fastening element 711 and the second fastening element 712 are two screws with the same thread-rotation direction or two screws with reverse thread-rotation directions. Certainly, in other embodiments, the main fixing plate 50 and the extension plate 70 are fastened in serial connection through other splicing connectors. The present disclosure is not limited thereto and not redundantly described herein.

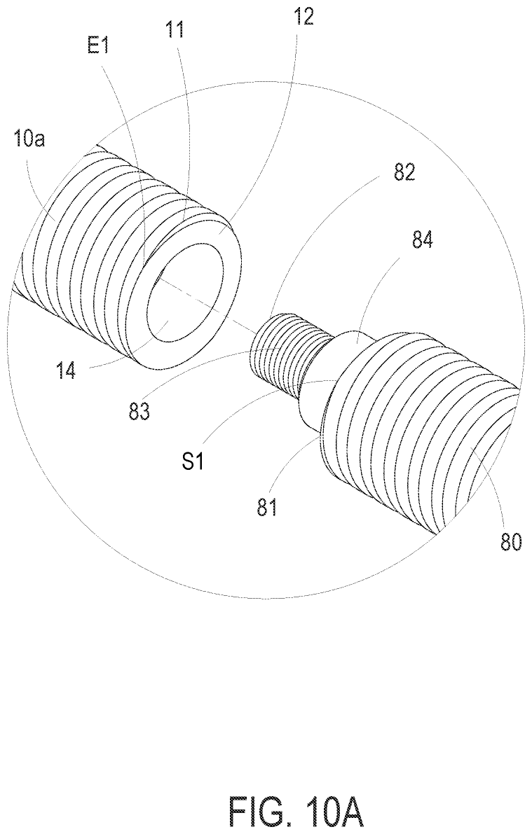

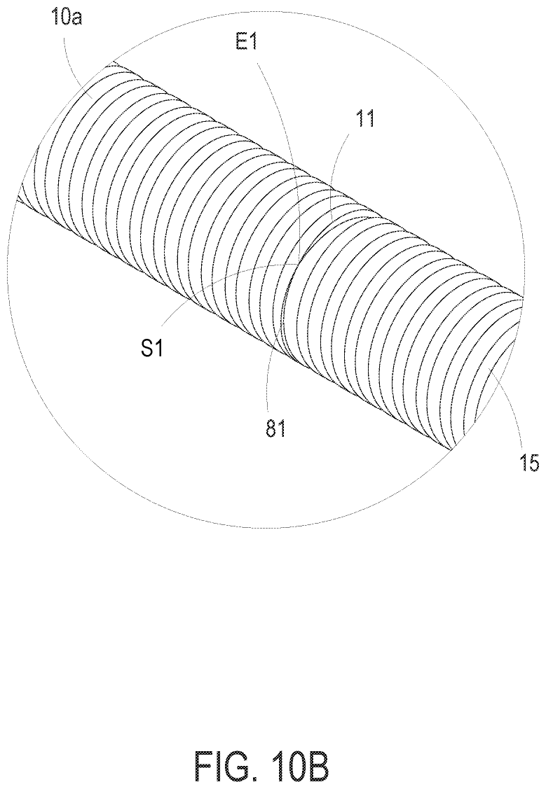

Please refer to FIG. 5 to FIG. 8, FIG. 10A and FIG. 10B. In the embodiment, the extension screw 80 is disposed on the extension plate 70. Moreover, the extension screw 80 is detachably connected to an extension end 12 of the screw-rod main body 10a. The extension screw 80 and the screw-rod main body 10a are arranged concentrically in the first direction (i.e., the X axial direction). In the embodiment, the screw-rod main body 10a includes a main external thread 11, the extension screw 80 includes an extension external thread 81. Preferably but not exclusively, the main external thread 11 has an ending point E1 continuously connected with a starting point S1 of the extension external thread 81.

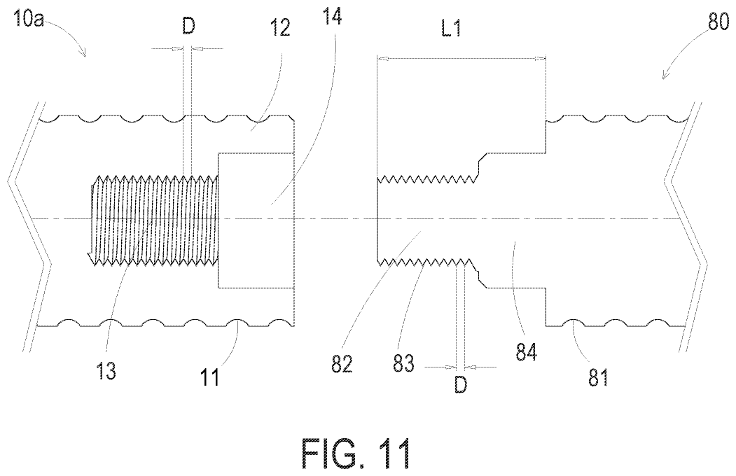

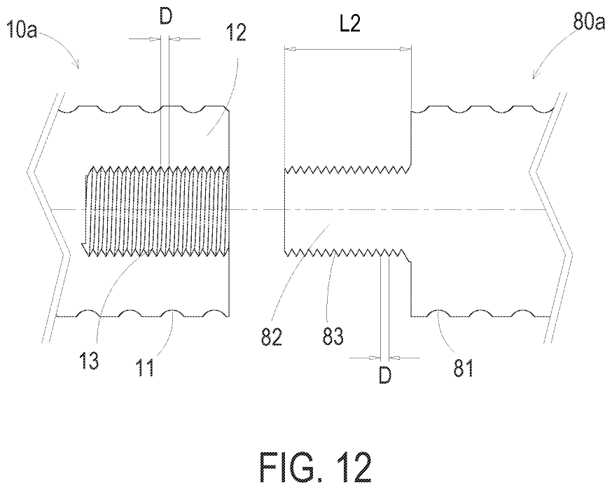

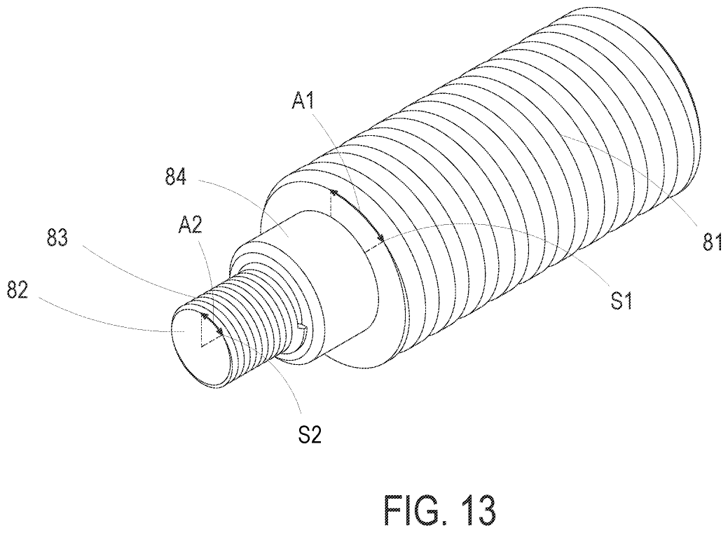

Please refer to FIG. 5 to FIG. 14. In the embodiment, the extension screw 80 includes a docking portion 82 and a supporting portion 85 disposed on two opposite ends. The docking portion 82 is detachably connected to the extension end 12 of the screw-rod main body 10a, so that the ending point E1 of the main external thread 11 is continuously connected with the starting point S1 of the extension external thread 81. Another end of the extension screw 80 is fixed on the extension plate 70 through the supporting portion 85 to provide the support. In the embodiment, the screw-rod main body 10a includes a front docking screw hole 13 disposed on the extension end 12. The docking portion 82 includes a docking external thread 83 spatially corresponding to the front docking screw hole 13. Preferably but not exclusively, in the embodiment, the internal thread of the front docking screw hole 13 and the docking external thread 83 have an identical thread pitch D, the docking portion 82 has a docking length L1, the docking length L1 is N times the thread pitch D, N is an integer, and N 1. In addition, the starting point S1 of the extension external thread 81 has an extension-thread leading angle A1. In the embodiment, a starting point S2 of the docking external thread 83 has a docking-thread leading angle A2, and the extension-thread leading angle A1 is equal to the docking-thread leading angle A2. Thereby, the ending point E1 of the main external thread 11 is continuously connected to the starting point S1 of the extension external thread 81.

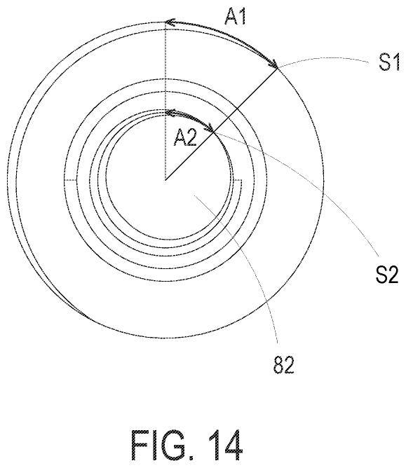

In the embodiment, the docking portion 82 further includes a positioning section 84 arranged between the docking external thread 83 and the extension external thread 81. The screw-rod main body 10a includes a front positioning opening 14 spatially corresponding to the positioning section 84. The front docking screw hole 13 is in communication with an exterior through the front positioning opening 14. With the alignment between the front positioning opening 14 and the positioning section 84, it helps to improve the combination efficiency of the extension screw 80 and the screw-rod main body 10a. In other embodiments, the positioning section 84 and the front positioning opening 14 are omitted, as shown in FIG. 14. By designing the docking length L2 of the docking portion 82 of the extension screw 80a to be N times the thread pitch D, the ending point E1 of the main external thread 11 is continuously connected to the starting point S1 of the extension external thread 81.

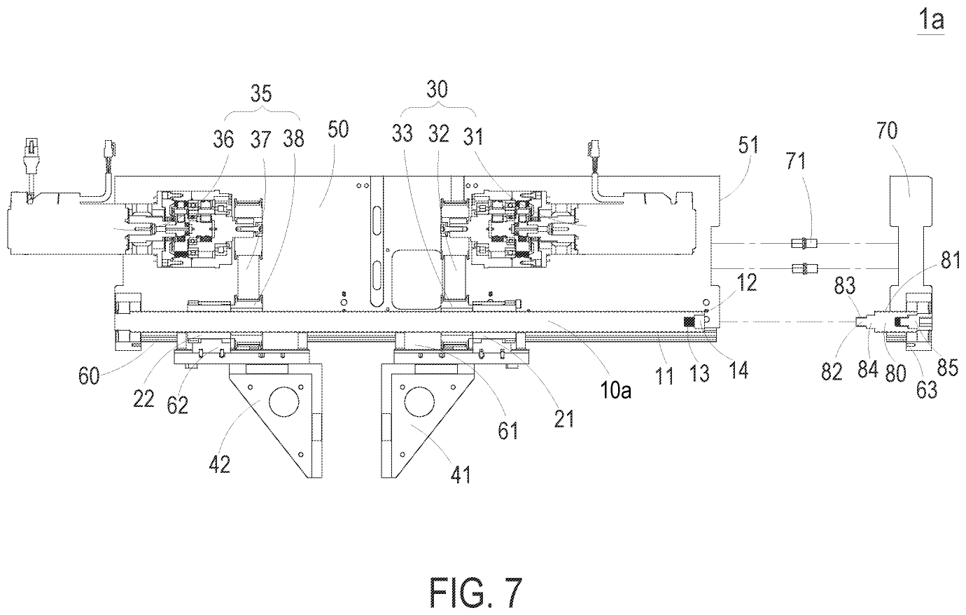

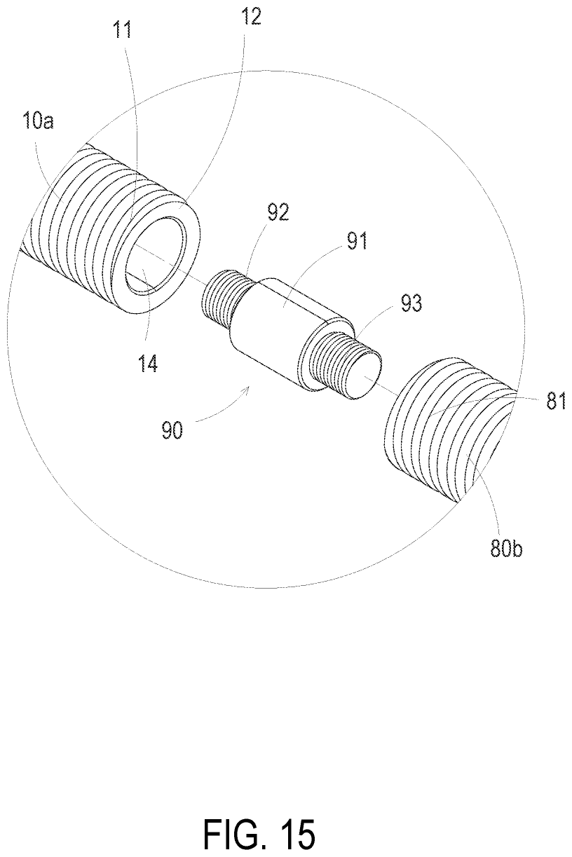

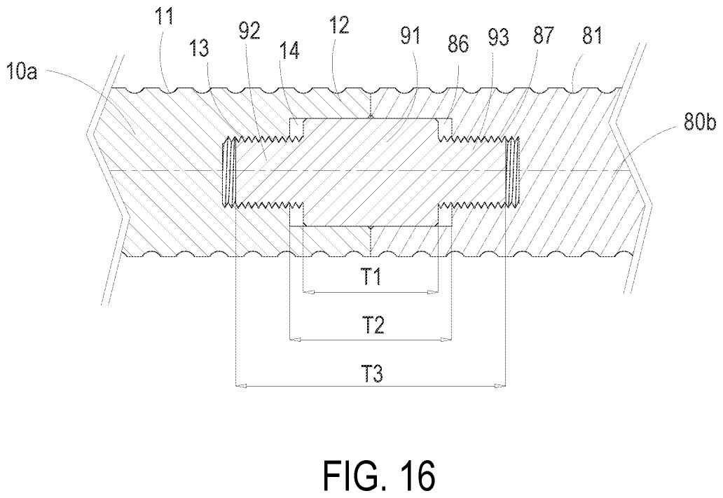

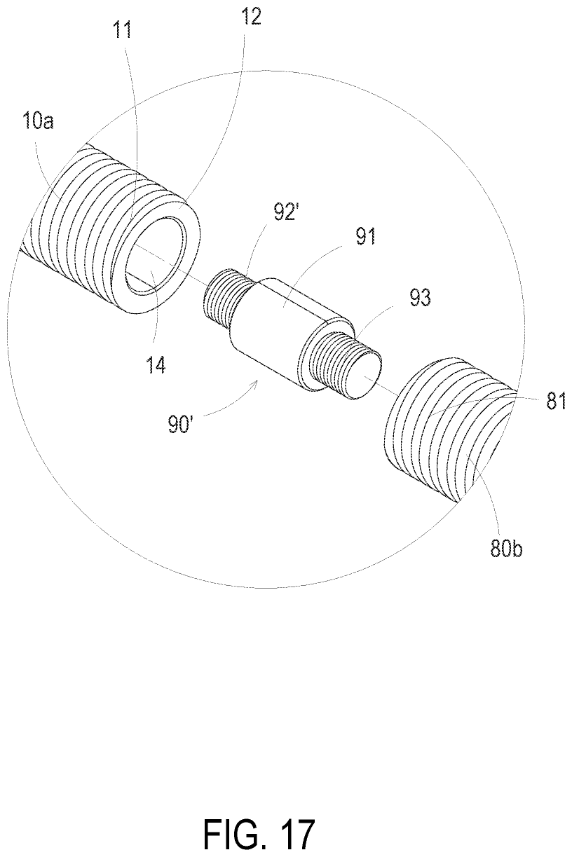

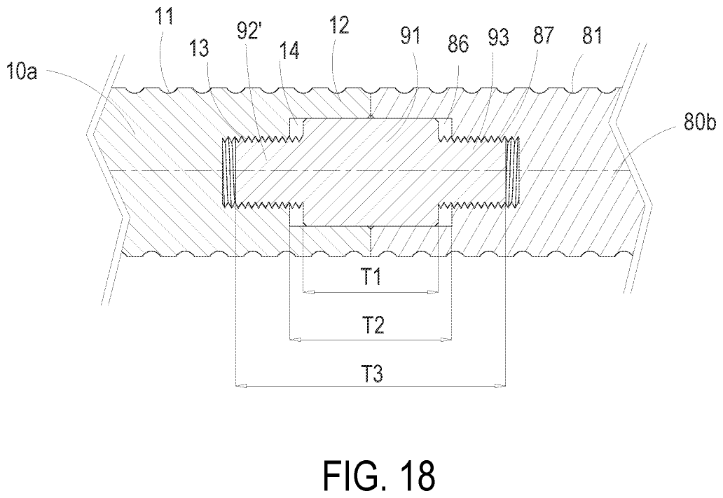

Notably, the combination of the extension screw 80 and the screw-rod main body 10a is not limited to the above-mentioned way. Please refer to FIG. 7, FIG. 15 and FIG. 16. In the embodiment, the screw-rod main body 10a and the extension screw 80b are docked through a docking element 90. In the embodiment, the screw-rod main body 10a includes a front docking screw hole 13 disposed on the extension end 12, the extension screw 80b includes a rear docking screw hole 87 and a supporting portion 85 (Referring to FIG. 7) disposed on two opposite ends, respectively. The supporting portion 85 is connected to the extension plate 70, the front docking screw hole 13 and the rear docking screw hole 87 are engaged with two opposite ends of the docking element 90, respectively, so that the extension screw 80b is docked with the extension end 12 of the screw-rod main body 10a. In the embodiment, the docking element 90 includes a positioning body 91, a front docking thread 92 and a rear docking thread 93. The front docking thread 92 and the rear docking thread 93 are arranged on two opposite ends of the positioning body 91 and configured to engage with the front docking screw hole 13 and the rear docking screw hole 87, respectively. Moreover, in the embodiment, the screw-rod main body 10a includes a front positioning opening 14 spatially corresponding to the positioning body 91, the front docking screw hole 13 is in communication with the exterior through the front positioning opening 14. In addition, the extension screw 80b includes a rear positioning opening 86 spatially corresponding to the positioning body 91, and the rear docking screw hole 87 is in communication with the exterior through the rear positioning opening 86. In the embodiment, the sum T2 of a length of the front positioning opening 14 and a length of the rear positioning opening 86 is greater than a length T1 of the positioning body 91 and less than a length T3 of the docking element 90. Thereby, the docking element 90 is accurately connected to the extension screw 80b and the screw-rod main body 10a, to achieve that the ending point E1 of the main external thread 11 is continuously connected to the starting point S1 of the extension external thread 81, as shown in FIG. 10B. As shown in FIG. 15, in an embodiment, a thread-rotation direction of the front docking thread 92 and a thread-rotation direction of the main external thread 11 are identical, but reverse to a thread-rotation direction of the rear docking thread 93. As shown in FIG. 17, in another embodiment, a thread-rotation direction of the front docking thread 92′ of the docking element 90′ and a thread-rotation direction of the main external thread 11 are reverse. Moreover, the thread-rotation direction of the front docking thread 92′ and a thread-rotation direction of the rear docking thread 93′ are reverse. In other embodiments, the thread-rotation directions of the docking external thread 83, the front docking thread 92, 92′, the rear docking thread 93, and the front docking screw hole 13 and the rear docking screw hole 87 corresponding thereto are adjustable according to the practical requirements. It is not limited to the thread-rotation directions of the main external thread 11 and the extension external thread 81. Certainly, the arrangement of the extension plate 70, the extension screw 80 and the extension rail 63 can be implemented on one side or both sides, and not limited to a symmetrical arrangement.

From the above, the first driving module 30 and the second driving module 35 are disposed on one single long-stroke screw rod of the screw-rod main body 10 and the extension screws 80, 80a, 80b through the rotatory ones of the first rotatory nut 21 and the second rotatory nut 22, respectively, and the two rotatory ones of the first rotatory nut 21 and the second rotatory nut are allowed to move and displace arbitrarily on the screw-rod main body 10 and the extension screws 80, 80a, 80b without being limited by the midline M. When the stroke length of the gripper structure 1a needs to be increased, an extension screw 80, 80a, 80b can be added at one end and/or both ends of the screw-rod main body 10a to increase the stroke length. There is no need to redesign the gripper structure 1a. It helpful of increasing the diversity of product applications. Certainly, the length of the screw-rod main body 10a, the number, the type and the length of the extension screws 80, 80a, 80b are adjustable according to the practical requirements. The present disclosure is no limited thereto.

In summary, the present disclosure provides a gripper structure having a single screw rod combined with two rotatory nuts, so as to allow the clamping elements connected to the rotatory nuts to move in full region without the midline restriction of the screw rod, avoid the torsional loss and enhance the support strength at the same time. The two rotatory nuts are connected to the corresponding driving modules, respectively, and configure to dispose on a single long-stroke screw rod. When the driving module, such as the motor combined with the belt, drives the corresponding rotatory nut to rotate, each of the two rotatory nuts is allowed to move arbitrarily on the screw-rod main body, so as to achieve the clamping operation without being limited by the midline of the screw-rod main body or the synchronous displacement of the two rotatory nuts. On the other hand, when the driving module and the corresponding rotatory nut are displaced and moved at the same time and the clamping element is connected thereto for the clamping operation, the driving module is stressed directly, and the problem of torsional loss due to the length of the screw-rod main body rod is avoided. In addition, the driving modules are disposed on one single screw-rod main body through the rotatory nuts, and the supporting positions of the driving modules are movable. When the rotatory nuts drive the clamping elements to perform the clamping operation, the force-bearing positions of the driving modules and the rotatory nuts are the supporting positions. It facilitates to enhance the supporting strength of the driving modules. Since two sets of driving modules are respectively mounted on one single long-stroke screw-rod main body through the corresponding rotatory nuts, it allows to move the respective one of the driving modules and the rotatory nuts without being limited by the midline of the screw rod. When the stroke length of the gripper structure needs to be increased, an extension screw can be added at one end and/or both ends of the screw-rod main body to increase the stroke length. There is no need to redesign the gripper structure. It helpful of increasing the diversity of product applications.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A gripper structure comprising:
a screw-rod main body extended along a first direction;
a first rotatory nut and a second rotatory nut sleeved on two sides of the screw-rod main body, respectively, and bilaterally symmetrical to each other;
a first driving module connected to the first rotatory nut, and configured to drive the first rotatory nut to rotate and displace relative to the screw-rod main body in the first direction, wherein the first rotatory nut is allowed to pass through a midline of the screw-rod main body;
a second driving module connected to the second rotatory nut, and configured to drive the second rotatory nut to rotate and displace relative to the screw-rod main body in the first direction, wherein the second rotatory nut is allowed to pass through the midline of the screw-rod main body; and
a first clamping element and a second clamping element connected to the first rotatory nut and the second rotatory nut, respectively, wherein when the first driving module drives the first rotatory nut or/and the second driving module drives the second rotatory nut, the first clamping element and the second clamping element are relatively displaced in the first direction and cooperated with each other to achieve a clamping operation.

2. The gripper structure according to claim 1, wherein the first driving module comprises a motor, a belt and a pulley, the pulley is concentrically connected with the first rotatory nut, the motor drives the pulley and the first rotatory nut to rotate through the belt, and the first rotatory nut is allowed to drive the first clamping element to move relative to the screw-rod main body in the first direction.

3. The gripper structure according to claim 1, wherein the second driving module comprises a motor, a belt and a pulley, the pulley is concentrically connected with the second rotatory nut, the motor drives the pulley and the second rotatory nut to rotate through the belt, and the second rotatory nut is allowed to drive the second clamping element to move relative to the screw-rod main body in the first direction.

4. The gripper structure according to claim 1, further comprising a main fixing plate, wherein the screw-rod main body is disposed on the main fixing plate.

5. The gripper structure according to claim 4, further comprising an extension plate detachably docked to a lateral end of the main fixing plate through a connection component in the first direction.

6. The gripper structure according to claim 5, wherein the connection component comprises a first fastening element, a second fastening element and a restricting element, the first fastening element and the second fastening element are arranged concentrically, an operation end of the first fastening element and an operation end of the second fastening element face each other, and the restricting element is disposed between the first fastening element and the second element and configured to restrict an axial direction between the first fastening element and the second fastening element.

7. The gripper structure according to claim 6, wherein the main fixing plate and the extension plate are docked with each other to form a window, and the operation end of the first fastening element and the operation end of the second fastening element are exposed through the window.

8. The gripper structure according to claim 6, wherein the first fastening element and the second fastening element are two screws with the same thread-rotation direction or two screws with reverse thread-rotation directions.

9. The gripper structure according to claim 6, wherein the connection component does not exceed an overlapping range of the extension plate and the main fixing plate along the first direction in a viewing direction of the first direction.

10. The gripper structure according to claim 5, further comprising a linear rail, a first sliding block and a second sliding block, wherein the linear rail is disposed on the main fixing plate along the first direction and spatially corresponding to the screw-rod main body, wherein the first clamping element is connected to the first rotatory nut through the first sliding block, and the first rotatory nut, the first sliding block and the first clamping element are allowed to displace relative to the screw-rod main body and the linear rail in the first direction; wherein the second clamping element is connected to the second rotatory nut through the second sliding block, and the second rotatory nut, the second sliding block and the second clamping element are allowed to displace relative to the screw-rod main body and the linear rail in the first direction.

11. The gripper structure according to claim 10, further comprising an extension rail disposed on the extension plate and connected to an end of the linear rail.

12. The gripper structure according to claim 5, further comprising an extension screw disposed on the extension plate and detachably connected to an extension end of the screw-rod main body, wherein the extension screw and the screw-rod main body are arranged concentrically in the first direction, the screw-rod main body comprises a main external thread, the extension screw comprises an extension external thread, and the main external thread has an ending point continuously connected with a starting point of the extension external thread.

13. The gripper structure according to claim 12, wherein the extension screw comprises a docking portion and a supporting portion disposed on two opposite ends, the docking portion is detachably connected to the extension end of the screw-rod main body, and the supporting portion is fixed on the extension plate.

14. The gripper structure according to claim 13, wherein the screw-rod main body comprises a front docking screw hole, the docking portion comprises a docking external thread, and the front docking screw hole and the docking external thread have an identical thread pitch, wherein the docking portion has a docking length, the docking length is N times the thread pitch, N is an integer, and N≥1.

15. The gripper structure according to claim 13, wherein the starting point of the extension external thread has an extension-thread leading angle, the screw-rod main body comprises a front docking screw hole disposed on the first extension end, the docking portion comprises a docking external thread corresponding to the front docking screw hole, wherein a starting point of the docking external thread comprises a docking-thread leading angle, and the extension-thread leading angle is equal to the docking-thread leading angle.

16. The gripper structure according to claim 15, wherein the docking portion further comprises a positioning section arranged between the docking external thread and the extension external thread, the screw-rod main body comprises a front positioning opening spatially corresponding to the positioning section, and the front docking screw hole is in communication with an exterior through the front positioning opening.

17. The gripper structure according to claim 12, wherein the screw-rod main body comprises a front docking screw hole disposed on the extension end, the extension screw comprises a rear docking screw hole and a supporting portion disposed on two opposite ends, respectively, the supporting portion is connected to the extension plate, the front docking screw hole and the rear docking screw hole are engaged with two opposite ends of a docking element, respectively, so that the extension screw is docked with the extension end of the screw-rod main body.

18. The gripper structure according to claim 17, wherein the docking element comprises a positioning body, a front docking thread and a rear docking thread, and the front docking thread and the rear docking thread are arranged on two opposite ends of the positioning body and configured to engage with the front docking screw hole and the rear docking screw hole, respectively, wherein the screw-rod main body comprises a front positioning opening spatially corresponding to the positioning body, the front docking screw hole is in communication with the exterior through the front positioning opening, the extension screw comprises a rear positioning opening spatially corresponding to the positioning body, and the rear docking screw hole is in communication with the exterior through the rear positioning opening.

19. The gripper structure according to claim 18, wherein the sum of a length of the front positioning opening and a length of the rear positioning opening is greater than a length of the positioning body and less than a length of the docking element.

20. The gripper structure according to claim 18, wherein a thread-rotation direction of the front docking thread and a thread-rotation direction of the rear docking thread are identical or reverse.
